(19) United States
(12) Patent Application Publication
(10) Pub. No.: US 2025/0158307 A1
(43) Pub. Date: May 15, 2025

(54) CONNECTION SYSTEM, PLUG, AND SUBSTRATE MEMBER

(71) Applicant: SUMITOMO ELECTRIC INDUSTRIES, LTD., Osaka (JP)

(72) Inventors: Yasunori ASANO, Osaka (JP); Takeshi Inoue, Osaka (JP)

(73) Assignee: SUMITOMO ELECTRIC INDUSTRIES, LTD., Osaka (JP)

(21) Appl. No.: 18/927,206

(22) Filed: Oct. 25, 2024

(30) Foreign Application Priority Data
Nov. 13, 2023 (JP) 2023-192791

(51) Int. Cl. H01R 12/79

(52) U.S. Cl. CPC H01R 12/79

(57) ABSTRACT

A connection system includes a plug and a substrate member. The plug includes a plurality of conductors, a plurality of terminals, and a first housing. Each of the plurality of terminals is electrically connected to a corresponding conductor among the plurality of conductors. The first housing holds distal end portions of the plurality of conductors and the plurality of terminals, and includes an end surface. The substrate member includes a first substrate. The first substrate includes a first main surface and a plurality of electrode pads disposed on the first main surface. Each of the plurality of terminals includes a distal end portion facing the first main surface on the end surface of the first housing. Each of the plurality of terminals includes a distal end portion configured to come into contact with a corresponding electrode pad among the plurality of electrode pads in an elastically deformed state.

### CROSS REFERENCE TO RELATED APPLICATIONS

This application claims priority based on Japanese Patent Application No. 2023-192791, filed on Nov. 13, 2023, and the entire contents of the Japanese patent application are incorporated herein by reference.

### TECHNICAL FIELD

The present disclosure relates to a connection system, a plug, and a substrate member.

### BACKGROUND

JP2016-129124A discloses an electrical connector mounted on a substrate. A plurality of conductive contacts are arranged in a multipolar manner inside a housing of the electrical connector. The conductive contacts are electrically connected to conductive paths on the substrate on which the electrical connector is mounted by solder bonding. In the above electrical connector, a signal transmission medium inserted into the housing is electrically connected to each conductive path on the substrate via the plurality of conductive contacts.

### SUMMARY

A connection system according to an embodiment of the present disclosure includes a plug and a substrate member. The plug includes a plurality conductor, a plurality of terminals, and a first housing. Each of the plurality of conductors extends along a first direction. Each of the plurality of terminals is electrically connected to a corresponding conductor among the plurality of conductors and extends along a second direction. The first housing holds distal end portions of the plurality of conductors and the plurality of terminals, and includes an end surface intersecting the second direction. The substrate member includes a first substrate. The first substrate includes a first main surface facing the end surface of the first housing in the second direction, and a plurality of electrode pads disposed on the first main surface. The plurality of conductors are arranged side by side in a third direction intersecting the first direction and the second direction. The plurality of terminals are arranged side by side in the third direction. The plug is attached to the substrate member. Each of the plurality of terminals includes a distal end portion facing the first main surface on the end surface of the first housing and configured to come into contact with a corresponding electrode pad among the plurality of electrode pads in an elastically deformed state.

### BRIEF DESCRIPTION OF THE DRAWINGS

FIG. 1 is a perspective view of a connection system according to an embodiment.

FIG. 2 is a cross-sectional view of the connection system taken along line II-II shown in FIG. 1.

FIG. 3 is an enlarged view of a region A surrounded by a dashed line in the connection system shown in FIG. 2.

FIG. 4 is a cross-sectional view of the connection system taken along line IV-IV shown in FIG. 1.

FIG. 5 is an enlarged view of the connection system shown in FIG. 4.

FIG. 6 is a perspective view showing a connection system according to a modification.

FIG. 7A is an enlarged view of a second housing and a second positioning member in a connection system according to the modification. FIG. 7B is a view of the second housing and the second positioning member shown in FIG. 7A as viewed from the second direction.

### DETAILED DESCRIPTION

In the electrical connector described in JP2016-129124A, the plurality of conductive contacts are arranged in a multipolar manner in the width direction of the electrical connector, and thus the length of the electrical connector in the width direction is increased. When the substrate is deformed by heat generated when the electrical connector is mounted on the substrate, the housing of the electrical connector cannot follow the deformation of the substrate, and the electrical connection between the plurality of conductive connectors and the respective conductive paths may be incomplete.

On the other hand, it is conceivable to reduce the length of the electrical connector in the width direction by narrowing the interval between the plurality of conductive contacts and mounting the plurality of conductive contacts at a high density. In this case, it is difficult to control the positional accuracy of each conductive contact, and it is difficult to control the coplanarity of each conductive contact. Thus, there is still a possibility that the electrical connection between the plurality of conductive connectors and the respective conductive paths may be incomplete.

An object of the present disclosure is to provide a connection system, a plug, and a substrate member, which can stably and electrically connect each terminal to each electrode pad corresponding to the terminal when a plurality of terminals are arranged in a multipolar manner.

### Description of Embodiments of Present Disclosure

First, the contents of embodiments of the present disclosure will be listed and explained.

[1] A connection system according to an embodiment of the present disclosure includes a plug and a substrate member. The plug includes a plurality of conductors, a plurality of terminals, and the first housing. Each of the plurality of conductors extends along a first direction. Each of the plurality of terminals is electrically connected to a corresponding conductor among the plurality of conductors and extends along a second direction. The first housing holds distal end portions of the plurality of conductors and the plurality of terminals, and includes an end surface intersecting the second direction. The substrate member includes a first substrate. The first substrate includes a first main surface facing the end surface of the first housing in the second direction, and a plurality of electrode pads disposed on the first main surface. The plurality of conductors are arranged side by side in a third direction intersecting the first direction and the second direction. The plurality of terminals are arranged side by side in the third direction. The plug is attached to the substrate member. Each of the plurality of terminals includes a distal end portion facing the first main surface on the end surface of the first housing and configured to come into contact with a corresponding electrode pad among the plurality of electrode pads in an elastically deformed state.

In this connection system, each of the plurality of terminals is in contact with the corresponding electrode pad among the plurality of electrode pads in an elastically deformed state. Since such a connection system is adopted, the plurality of electrode pads can be provided on the first main surface of the first substrate, and the positions of the plurality of electrode pads can be controlled with high accuracy. Thus, the plurality of electrode pads and the plurality of terminals can be mounted at high density, and the length of the plug in the third direction can be reduced. As a result, when the plurality of terminals are arranged in a multipolar manner, each terminal can be stably and electrically connected to each electrode pad corresponding to the terminal.

[2] In the connection system of the above [1], the plug may further include a relay member held by the first housing and holding a proximal end portion of each of the plurality of terminals in the second direction. The proximal end portion of each of the plurality of terminals may be electrically connected to a corresponding conductor among the plurality of conductors at the relay member. In this case, the position of the proximal end portion of each of the plurality of terminals can be adjusted by changing the size and position of the relay member. Thus, it is possible to adjust the position of the distal end portion of each of the plurality of terminals. As a result, when the plurality of terminals are arranged in a multipolar manner, each terminal can be electrically connected to each electrode pad corresponding to the terminal more stably.

[3] In the connection system according to the above [1] or [2], the substrate member may further include a second housing accommodating the plug such that the first direction in which the plurality of conductors extend intersects the second direction and the plug and the first substrate are positioned with respect to each other. In this case, the plurality of terminals of the plug are positioned with respect to the plurality of electrode pads of the first substrate. Thus, when the plurality of terminals are arranged in a multipolar manner, each terminal can be electrically connected to the electrode pad corresponding to the terminal more stably. Further, since the plug and the first substrate are positioned such that the first direction intersects the second direction, the length of the connection system in the second direction is reduced, and the height of the connection system can be reduced.

[4] In the connection system according to the above [3], the plurality of conductors may be arranged side by side in the second direction in a cross section of the first housing intersecting the third direction. The plurality of terminals may be arranged side by side in the first direction in the cross section of the first housing intersecting the third direction. In this case, the number of the plurality of electrode pads and the number of the plurality of terminals can be increased without increasing the length of the plug in the third direction.

[5] In the connection system according to the above [3] or [4], the substrate member may further include a second substrate including a second main surface intersecting the second direction, and a first positioning member disposed on the second main surface and configured to position the second housing with respect to the second substrate in a direction intersecting the second direction. In this case, the second housing can be positioned with respect to the second substrate in a direction intersecting the second direction. Thus, each terminal can be electrically connected to each electrode pad corresponding to the terminal more stably.

[6] In the connection system according to the above [5], the substrate member may further include a first securing member configured to secure the second housing and the first positioning member to the second main surface of the second substrate. In this case, the second housing and the first positioning member can be secured with respect to the second substrate. Thus, each terminal can be electrically connected to each electrode pad corresponding to the terminal more stably.

[7] In the connection system according to the above [6], the first securing member may include a first main body and a first screw member configured to secure the first main body to the second main surface of the second substrate. In this case, the second housing and the first positioning member can be secured with respect to the second substrate more firmly. Thus, each terminal can be electrically connected to each electrode pad corresponding to the terminal more stably.

[8] In the connection system according to the above [3] or [4], the substrate member may further include a second positioning member disposed on the first main surface and configured to position the second housing with respect to the first substrate in a direction intersecting the second direction. In this case, the second housing can be positioned with respect to the first substrate in a direction intersecting the second direction. Thus, each terminal can be electrically connected to each electrode pad corresponding to the terminal more stably.

[9] In the connection system according to the above [8], the substrate member may further include a second securing member configured to secure the second housing and the second positioning member to the first main surface of the first substrate. In this case, the second housing can be secured with respect to the first substrate. Thus, each terminal can be electrically connected to each electrode pad corresponding to the terminal more stably.

[10] In the connection system according to the above [9], the second securing member may further include a second main body and a second screw member configured to secure the second main body to the first main surface of the first substrate. In this case, the second housing can be secured with respect to the first substrate more firmly. Thus, each terminal can be electrically connected to each electrode pad corresponding to the terminal more stably.

[11] In the connection system according to any one of the above [8] to [10], the second positioning member may include a third main body and a third securing member protruding from the third main body in the direction intersecting the second direction and secured to the first main surface of the first substrate. In this case, the second positioning member can be secured with respect to the first substrate. Thus, each terminal can be electrically connected to each electrode pad corresponding to the terminal more stably.

[12] A plug according to an embodiment is attachable to a substrate member including a plurality of electrode pads. The plug includes a plurality of conductors, a plurality of terminals, and a first housing. Each of the plurality of conductors extends along the first direction. Each of the plurality of terminals is electrically connected to a corresponding conductor among the plurality of conductors. Each of the plurality of terminals extends along a second direction. The first housing holds distal end portions of the plurality of conductors and the plurality of terminals. The first housing includes an end surface intersecting the second direction. The plurality of conductors are arranged side by side in a third direction intersecting the first direction and the second direction. The plurality of terminals are arranged side by side in the third direction. Each of the plurality of terminals includes a distal end portion protruding from the end surface of the first housing and configured to be contactable with a corresponding electrode pad among the plurality of electrode pads in an elastically deformed state. The plug having such a configuration can achieve the same effect as the connection system described above.

[13] In the plug according to the above [12], the plug may further include a relay member held by the first housing and holding a proximal end portion of each of the plurality of terminals in the second direction. The proximal end portion of each of the plurality of terminals in the second direction may be electrically connected to a corresponding conductor among the plurality of conductors at the relay member. In this case, the position of the distal end portion of each of the plurality of terminals can be adjusted by changing the size and position of the relay member.

[14] As one embodiment, the substrate member is attachable to a plug including an end surface from which a plurality of terminals, each extending along a second direction, are exposed. The substrate member includes a substrate. The substrate includes a main surface intersecting the second direction, and a plurality of electrode pads disposed on the main surface and each configured to be electrically connectable to a corresponding terminal among the plurality of terminals. The substrate having such a configuration can achieve the same effect as the connection system described above.

[15] The substrate member according to the above may further include a second housing that accommodates the plug such that the plug and the first substrate are positioned with respect to each other. In this case, the plurality of terminals of the plug are positioned with respect to the plurality of electrode pads of the first substrate. Thus, when the plurality of terminals are arranged in a multipolar manner, each terminal can be electrically connected to each electrode pad corresponding to the terminal more stably.

### Details of Embodiments of Present Disclosure

Specific examples of a connection system, a plug, and a substrate member according to embodiments of the present disclosure will be described below with reference to the drawings. In the following description, the same elements or elements having the same functions are denoted by the same reference numerals, and redundant description will be omitted. The present invention is not limited to these examples, but is defined by the scope of the claims, and is intended to include all modifications within the meaning and scope equivalent to the scope of the claims.

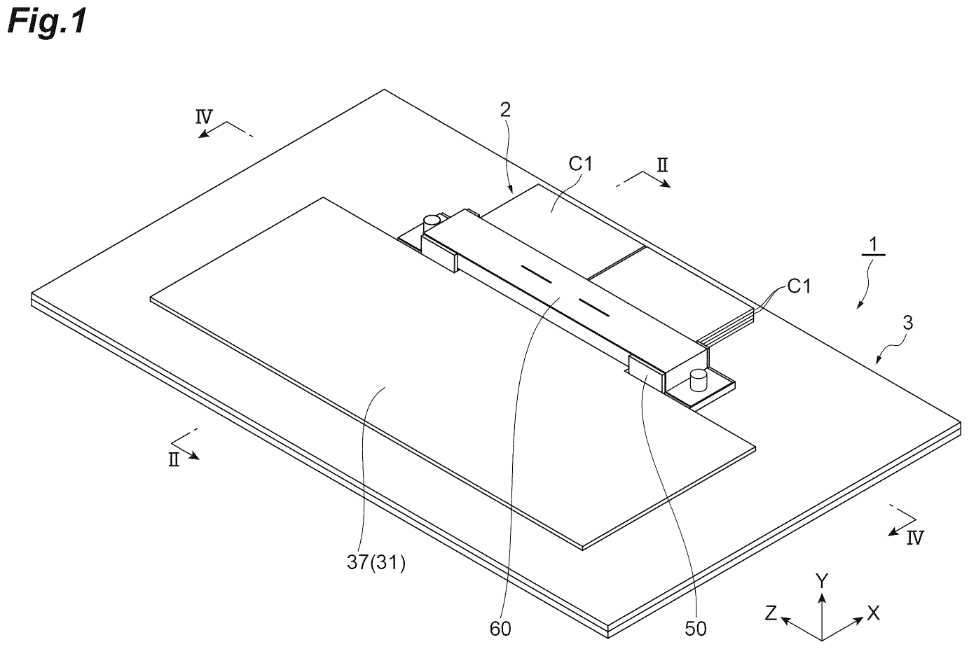

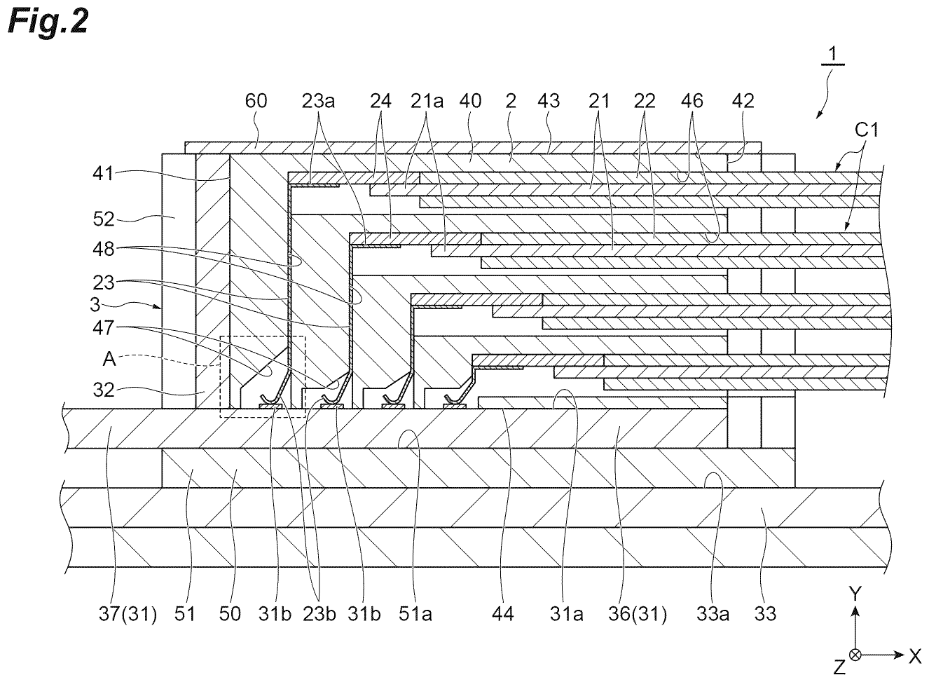

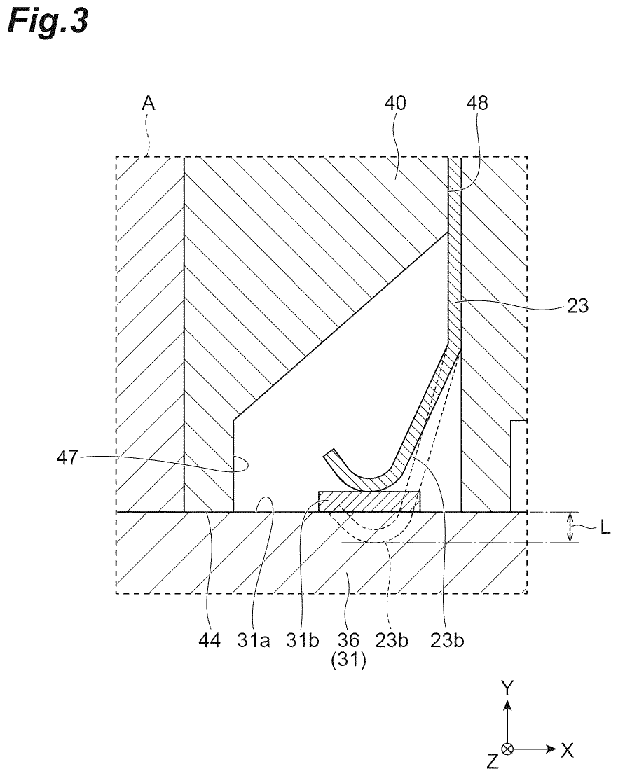

FIG. 1 is a perspective view of a connection system according to an embodiment. FIG. 2 is a cross-sectional view of the connection system taken along line II-II shown in FIG. 1. FIG. 3 is an enlarged view of a region A surrounded by a dashed line in the connection system shown in FIG. 2. As shown in FIGS. 1 to 3, a connection system 1 includes a plug 2 and a substrate member 3. In connection system 1, plug 2 is attached to substrate member 3.

As shown in FIG. 2, plug 2 has a plurality of electric wires 21 (a plurality of conductors), a plurality of coating members 22, a plurality of terminals 23, a plurality of relay members 24, and a plug housing 40 (first housing). Hereinafter, a direction in which electric wire 21 extends is referred to as an X direction (first direction), a direction in which terminal 23 extends and which intersects the X direction is referred to as a Y direction (second direction), and a direction which intersects the X direction and the Y direction is referred to as a Z direction (third direction).

The plurality of electric wires 21 are members for transmitting electric power and/or an electric signal. Electric wire 21 is formed of a metal such as copper. Each of the plurality of electric wires 21 extends along the X direction. The plurality of electric wires 21 are arranged side by side in the Z direction. The plurality of electric wires 21 are also arranged in the Y direction in a cross section of plug housing 40 intersecting the Z direction. The plurality of coating members 22 are members that cover portions of the plurality of electric wires 21 except for distal end portions 21a. The length of distal end portion 21a in the X direction is, for example, about 1 mm, but can be adjusted in consideration of the mounting strength of each component and the specifications of the transmission characteristics. The material of coating member 22 is, for example, a resin such as polyester. Each coating member 22 integrates the plurality of electric wires 21 arranged side by side in the Z direction among the plurality of electric wires 21, and thus the plurality of electric wires 21 side by side arranged in the Z direction and coating member 22 form each cable C1. Cable C1 is, for example, a flexible flat cable (FFC). Each coating member 22 may integrate the plurality of electric wires 21 arranged in the Y direction and the Z direction among the plurality of electric wires 21.

The plurality of terminals 23 are members for transmitting electric power and/or an electric signal. Terminal 23 is formed of a metal such as copper. Each of the plurality of terminals 23 extends along the Y direction. The plurality of terminals 23 are arranged side by side in the Z direction. The plurality of terminals 23 are also arranged in the X direction in the cross section of plug housing 40 intersecting the Z direction. A proximal end portion 23a of each of the plurality of terminals 23 in the Y direction is held by relay member 24. For example, proximal end portion 23a is soldered to relay member 24. Proximal end portion 23a is electrically connected to the corresponding electric wire 21 among the plurality of electric wires 21 in the wiring of relay member 24.

Referring to FIG. 3, a distal end portion 23b of each of the plurality of terminals 23 is configured to be elastically deformable in the Y direction, and has, for example, a J-shape. Distal end portion 23b is configured to come into contact with a corresponding electrode pad 31b among the plurality of electrode pads 31b (described later) in an elastically deformed state. Distal end portion 23b faces a first main surface 31a (described later) of a first substrate 31 on a second side surface 44 (described later) of plug housing 40. Distal end portion 23b protrudes from second side surface 44 of plug housing 40 in a state before distal end portion 23b is in contact with electrode pad 31b. For example, a length L by which distal end portion 23b protrudes from second side surface 44 may be 10 μm to 1000 μm, and is, for example, 200 μm.

Reference is again made to FIG. 2. The plurality of relay members 24 are members for relaying electrical connection between the plurality of electric wires 21 and the plurality of terminals 23. Relay member 24 has, for example, a plate shape, and is a paddle card as an example. Each of the plurality of relay members 24 extends along the X direction and the Z direction. The plurality of relay members 24 are arranged along the Y direction. Each relay member 24 holds each proximal end portion 23a of the plurality of terminals 23 arranged side by side in the Z direction. Distal end portions 21a of electric wires 21 arranged side by side in the Z direction and proximal end portions 23a of terminals 23 arranged side by side in the Z direction are electrically connected to the wiring of relay member 24.

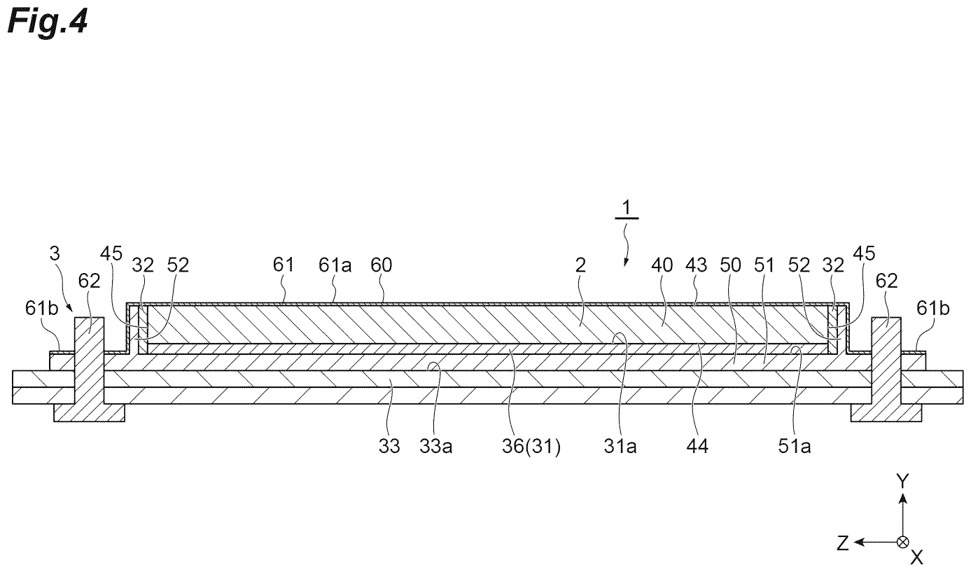

Plug housing 40 is a rectangular parallelepiped member that holds the plurality of electric wires 21, a plurality of terminals 23, and relay members 24. The material of plug housing 40 is, for example, a resin such as polyphenylene sulfide (PPS). Plug housing 40 has a front end surface 41, a rear end surface 42, a first side surface 43, a second side surface (end surface) 44, and a pair of third side surfaces 45 (see FIG. 4).

Front end surface 41 and rear end surface 42 extend along the Y direction and the Z direction. Rear end surface 42 is located on the opposite side of front end surface 41 in the X direction. First side surface 43 and second side surface 44 intersect the Y direction and extend along the X direction and the Z direction. Second side surface 44 is located on the opposite side of first side surface 43 in the Y direction. The pair of third side surfaces 45 extends along the X direction and the Y direction. One of the pair of third side surfaces 45 is located on the opposite side of the other third side surface 45 in the Z-direction.

Plug housing 40 further has a plurality of holding holes 46, a plurality of recesses 47, and a plurality of hole portions 48. The plurality of holding holes 46 extend along the X direction and the Z direction. The plurality of holding holes 46 are arranged in the Y direction. Holding holes 46 are opened in rear end surface 42 and extend from rear end surface 42 to the inside of plug housing 40. Each of the plurality of holding holes 46 holds cable C1 and relay member 24. For example, relay member 24 is secured to plug housing 40 by press-fitting, with an adhesive, or the like. Thus, plug housing 40 holds distal end portions 21a of the plurality of electric wires 21, the plurality of terminals 23, and relay members 24.

The plurality of recesses 47 are opened in second side surface 44. Each of the plurality of recesses 47 extends along the Z direction. The plurality of recesses 47 are arranged in the X-direction. Each of the plurality of hole portions 48 extends along the Y direction and the Z direction. Each recess 47 communicates with the corresponding holding hole 46 among the plurality of holding holes 46 through the corresponding hole portion 48 among the plurality of hole portions 48.

Each of the plurality of terminals 23 extends from the bottom of holding hole 46 to the inside of recess 47 through hole portion 48. Thus, by adjusting the position of relay member 24 in the X direction, the position of distal end portion 23b of each terminal 23 held by relay member 24 in the Y direction can be adjusted. Thus, the length of distal end portion 23b of each terminal 23 protruding from second side surface 44 of plug housing 40 can be adjusted, and the amount of spring displacement of distal end portion 23b of each terminal 23 when plug 2 is attached to substrate member 3 can be adjusted.

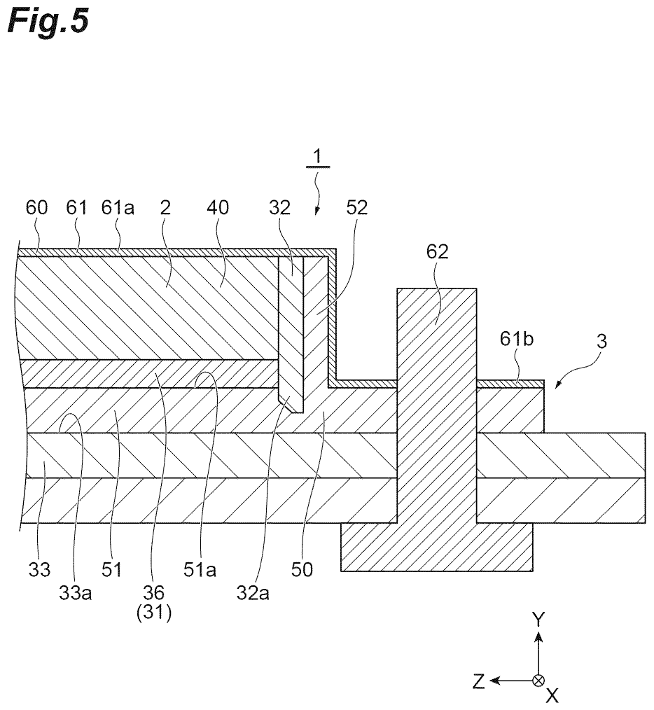

Next, substrate member 3 will be described with reference to FIGS. 2 to 5. FIG. 4 is a cross-sectional view of connection system 1 taken along line IV-IV shown in FIG. 1. FIG. 5 is an enlarged view of connection system 1 shown in FIG. 4. In FIGS. 4 and 5, members other than plug housing 40 in plug 2 are not shown. As shown in FIGS. 1 and 2, substrate member 3 has first substrate 31 (substrate), a receptacle housing 32 (second housing), a second substrate 33, a first positioning member 50, and a first securing member 60.

First substrate 31 extends along the X direction and the Z direction. First substrate 31 has a first portion 36 and a second portion 37 arranged in the X direction. First portion 36 extends so as to overlap plug 2 when viewed from the Y direction. Second portion 37 extends so as not to overlap plug 2 when viewed from the Y direction. Second portion 37 is contiguous with first portion 36 in the X direction through an opening (not shown) of receptacle housing 32 and an opening (not shown) of first positioning member 50.

First portion 36 has first main surface 31a and the plurality of electrode pads 31b. First main surface 31a faces second side surface 44 of plug housing 40 in the Y direction. The plurality of electrode pads 31b are provided on first main surface 31a and arranged side by side in the X direction and the Z direction. Each of the plurality of electrode pads 31b is in contact with distal end portion 23b of the corresponding terminal 23 among the plurality of terminals 23.

As shown in FIGS. 2 and 4, receptacle housing 32 extends to cover front end surface 41 and the pair of third side surfaces 45 of plug 2, and has, for example, a U-shape. Receptacle housing 32 accommodates plug 2 and first portion 36 of first substrate 31 so as to position plug 2 and first substrate 31 with respect to each other in the X direction and the Z direction. Receptacle housing 32 regulates the position of plug 2 in the X direction and the Z direction (in the front, rear, left, and right directions in the horizontal plane) when plug 2 is inserted. As shown in FIG. 5, a lower end 32a of receptacle housing 32 protrudes into the inside of first positioning member 50.

Second substrate 33 has a second main surface 33a facing first portion 36 of first substrate 31 and receptacle housing 32 in the Y direction. Second main surface 33a intersects the Y direction and extends along the X direction and the Z direction.

First positioning member 50 is a member that positions receptacle housing 32 with respect to second substrate 33 in a direction intersecting the Y direction. First positioning member 50 has a plate portion 51 and two wall portions 52. Plate portion 51 is provided on second main surface 33a. Plate portion 51 has a third main surface 51a extending along the X direction and the Z direction. First portion 36 of first substrate 31 and receptacle housing 32 are disposed on third main surface 51a. Two wall portions 52 are provided on third main surface 51a. Two wall portions 52 are arranged in the Z-direction. Two wall portions 52 are disposed on the opposite side of plug housing 40 with respect to receptacle housing 32. One wall portion 52 extends along a part of front end surface 41 of plug housing 40 and one third side surface 45 when viewed from the Y direction, and has, for example, a V-shape. The other wall portion 52 extends along another part of front end surface 41 and the other third side surface 45 when viewed from the Y direction, and has, for example, a V-shape. Two wall portions 52 position, on second main surface 33a, first portion 36 of first substrate 31 and receptacle housing 32 with respect to second substrate 33. Two wall portions 52 align the relative positions of receptacle housing 32 and the plurality of electrode pads 31b.

First securing member 60 secures receptacle housing 32 and first positioning member 50 to second main surface 33a of second substrate 33. First securing member 60 has a first main body 61 and two first screw members 62. First main body 61 has a central portion 61a and two end portions 61b. Central portion 61a is disposed on the opposite side of plug 2, receptacle housing 32, and wall portion 52 of first positioning member 50 in the Y direction. Two end portions 61b are arranged so as to sandwich central portion 61a. Each end portion 61b is disposed on the opposite side of wall portion 52 of first positioning member 50 in the Y direction. Two first screw members 62 are arranged to sandwich plug 2, receptacle housing 32, and wall portion 52 of first positioning member 50. Each first screw member 62 penetrates second substrate 33, plate portion 51 of first positioning member 50, and each end portion 61b. Two first screw members 62 secure plate portion 51 of first positioning member 50 with respect to second substrate 33 by screwing. Two first screw members 62 secure first main body 61 with respect to second substrate 33 by screwing.

As described above, in connection system 1 according to the embodiment, the plurality of terminals 23 are in contact with the corresponding electrode pads 31b among the plurality of electrode pads 31b in an elastically deformed state. Since such connection system 1 is adopted, the plurality of electrode pads 31b can be provided on first main surface 31a of first substrate 31, and the positions of the plurality of electrode pads 31b can be controlled with high accuracy. Thus, the plurality of electrode pads 31b and the plurality of terminals 23 can be mounted at high density, and the length of plug 2 in the Z direction can be reduced. As a result, when the plurality of terminals 23 are arranged in a multipolar manner, each terminal 23 can be stably and electrically connected to each electrode pad 31b corresponding to terminal 23.

In connection system 1, since it is not necessary to control the coplanarity between the plurality of electrode pads 31b with high accuracy, it is allowed to reduce the length of plug 2 in the Z direction and to increase the length of plug 2 in the Y direction. Thus, it is possible to reduce the area occupied by plug 2 on first substrate 31. As a result, other components can be further mounted on first substrate 31, or the manufacturing cost of connection system 1 can be reduced by reducing the size of first substrate 31.

In connection system 1, when the plurality of terminals 23 are arranged in a multipolar manner, each terminal 23 can be stably and electrically connected to each electrode pad 31b corresponding to terminal 23 without using a high-precision assembly device or the like. In addition, since connection system 1 uses the plurality of electrode pads 31b instead of the plurality of conductive contacts, a process of arranging the plurality of conductive contacts so that the conductive contacts have perfect flatness in the initial state is not required when connection system 1 is manufactured. Further, since the length of connection system 1 in the Z direction is smaller than that the conventional connection system, even when first substrate 31 and second substrate 33 are deformed due to heat generated when the members are mounted on second substrate 33 of substrate member 3, each housing can follow the deformation. Thus, it is not necessary to consider the deformation when setting the reflow condition of each component, and thus the reflow condition can be easily matched among the plurality of components in connection system 1. As a result, the manufacturing cost of connection system 1 can be reduced.

In connection system 1, plug 2 has relay member 24 that is held by plug housing 40 and holds proximal end portion 23a of each of the plurality of terminals 23 in the Y direction. Proximal end portion 23a of each of the plurality of terminals 23 is electrically connected to the corresponding electric wire 21 among the plurality of electric wires 21 at relay member 24. In this case, the position of proximal end portion 23a of each of the plurality of terminals 23 can be adjusted by changing the size and position of relay member 24. Thus, it is possible to adjust the position of distal end portion 23b of each of the plurality of terminals 23. As a result, when the plurality of terminals 23 are arranged in a multipolar manner, each terminal 23 can be electrically connected to each electrode pad 31b corresponding to terminal 23 more stably.

In connection system 1, substrate member 3 has receptacle housing 32 accommodating plug 2 such that plug 2 and first substrate 31 are positioned with respect to each other. In this case, the plurality of terminals 23 of plug 2 are positioned with respect to the plurality of electrode pads 31b of first substrate 31. Thus, when the plurality of terminals 23 are arranged in a multipolar manner, each terminal 23 can be electrically connected to electrode pad 31b corresponding to terminal 23 more stably. Further, since plug 2 and first substrate 31 are positioned such that the direction in which the plurality of electric wires 21 extend intersects the direction in which the plurality of terminals 23 extend, the length of connection system 1 in the Y direction is reduced, and the height of connection system 1 can be reduced as compared with the conventional FFC connector and card edge connector.

In connection system 1, the plurality of electric wires 21 are arranged in the Y direction in the cross section of plug housing 40 intersecting the Z direction. The plurality of terminals 23 are arranged in the X direction in the cross section of plug housing 40 intersecting the Z direction. In this case, the number of the plurality of electrode pads 31b and the number of the plurality of terminals 23 can be increased without increasing the length of plug 2 in the Z direction.

In connection system 1, substrate member 3 has second substrate 33 including second main surface 33a intersecting the Y direction, and first positioning member 50 disposed on second main surface 33a and configured to position receptacle housing 32 with respect to second substrate 33 in the direction intersecting the Y direction. In this case, receptacle housing 32 can be positioned with respect to second substrate 33 in a direction intersecting the Y direction. Thus, each terminal 23 can be electrically connected to electrode pad 31b corresponding to terminal 23 more stably.

In connection system 1, substrate member 3 has first securing member 60 for securing receptacle housing 32 and first positioning member 50 to second main surface 33a of second substrate 33. In this case, receptacle housing 32 and first positioning member 50 can be secured with respect to second substrate 33. Thus, each terminal 23 can be electrically connected to each electrode pad 31b corresponding to terminal 23 more stably.

In connection system 1, first securing member 60 includes first main body 61 and first screw members 62 that secure first main body 61 to second main surface 33a of second substrate 33. In this case, receptacle housing 32 and first positioning member 50 can be secured with respect to second substrate 33 more firmly. Thus, each terminal 23 can be electrically connected to each electrode pad 31b corresponding to terminal 23 more stably.

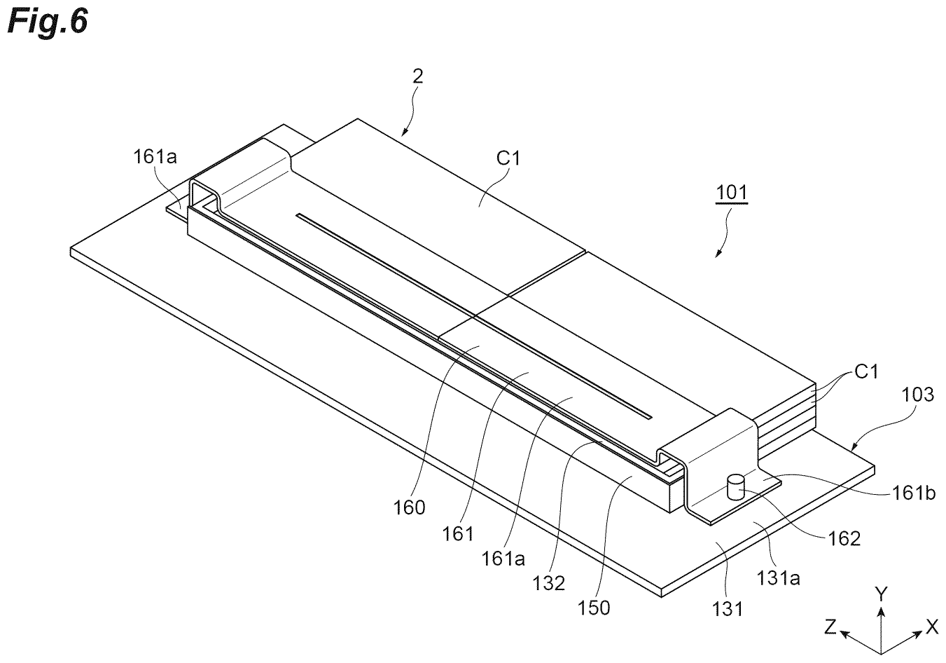

Although the embodiments of the present disclosure have been described in detail, the present disclosure is not limited to the above-described embodiments, and can be applied to various embodiments. For example, in connection system 1, substrate member 3 can exclude first positioning member 50 and second substrate 33. FIG. 6 is a perspective view showing a connection system 101 according to a modification. Connection system 101 has plug 2 and a substrate member 103. Plug 2 has the plurality of electric wires 21, the plurality of coating members 22, the plurality of terminals 23, the plurality of relay members 24, and plug housing 40, as in the above embodiment.

Substrate member 103 has a first substrate 131 (substrate), a receptacle housing 132 (second housing), a second positioning member 150, and a second securing member 160. First substrate 131 has a first main surface 131a and the plurality of electrode pads 31b, as in the above embodiment. Receptacle housing 132 is provided on first main surface 131a and extends so as to surround plug 2.

Second securing member 160 secures receptacle housing 132 and second positioning member 150 to first main surface 131a of first substrate 131. Second securing member 160 has a second main body 161 and second screw members 162. Second main body 161 has a central portion 161a and two end portions 161b. Central portion 161a is disposed on the opposite side of first substrate 131 with respect to plug 2, receptacle housing 132, and second positioning member 150. Two end portions 161b are arranged so as to sandwich central portion 161a in the Z direction. Each end portion 161b is provided on first main surface 131a. Each second screw member 162 penetrates first substrate 131 and each end portion 161b. Second screw member 162 secures second main body 161 with respect to first main surface 131a of first substrate 131 by screwing.

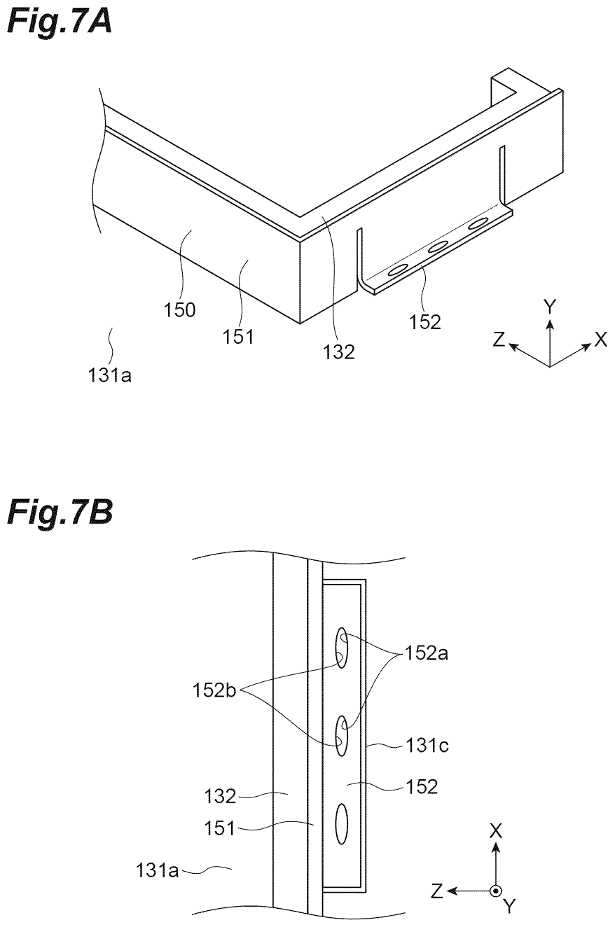

Second positioning member 150 is provided on first main surface 131a, and positions receptacle housing 132 with respect to first substrate 131 in a direction intersecting the Y direction. FIG. 7A is an enlarged view of receptacle housing 132 and second positioning member 150 in connection system 101. FIG. 7B is a view of receptacle housing 132 and second positioning member 150 shown in FIG. 7A as viewed from the Y direction.

Second positioning member 150 has a third main body 151 and two third securing members 152. Third main body 151 is disposed on first main surface 131a. Third main body 151 extends so as to surround receptacle housing 132 in the Y direction. Two third securing members 152 are disposed so as to sandwich third main body 151 in the Z-direction. Each of third securing members 152 protrudes from third main body 151 in the Z-direction. Each of third securing members 152 extends along the extending direction of third main body 151 and has a rectangular shape. Third securing member 152 is, for example, a peg terminal. Each third securing member 152 is secured to a pad 131c on first main surface 131a with an adhesive or the like. Pad 131c is provided in a range of about an allowable tolerance of a positional deviation from the region in which third securing member 152 is mounted on first main surface 131a. For example, when viewed from the Y direction, third securing member 152 is offset from the outer edge of pad 131c by about 0.05 mm.

Each third securing member 152 has a plurality of holes 152a penetrating third securing member 152 along the Y direction. A fillet 152b is formed inside each hole 152a. Hole 152a serves as a passage for gas when second positioning member 150 is mounted on first main surface 131a of first substrate 131 by soldering, and thus the solder is degassed more efficiently. Further, by fillet 152b, third main body 151 is more firmly held by first substrate 131.

In connection system 101 according to the modification, similarly to the above embodiment, when the plurality of terminals 23 are arranged in a multipolar manner, each terminal 23 can be stably and electrically connected to each electrode pad 31b corresponding to terminal 23.

In connection system 101 according to the modification, substrate member 103 has second positioning member 150 disposed on first main surface 131a and is configured to position receptacle housing 132 with respect to first substrate 131 in the direction intersecting the Y direction. In this case, receptacle housing 132 can be positioned with respect to first substrate 131 in a direction intersecting the Y direction. Thus, each terminal 23 can be electrically connected to each electrode pad 31b corresponding to terminal 23 more stably.

In connection system 101 according to the modification, substrate member 103 has second securing member 160 that secures receptacle housing 132 and second positioning member 150 to first main surface 131a of first substrate 131. In this case, receptacle housing 132 can be secured with respect to first substrate 131. Thus, each terminal 23 can be electrically connected to each electrode pad 31b corresponding to terminal 23 more stably.

In connection system 101 according to the modification, second securing member 160 has second main body 161 and second screw members 162 that secure second main body 161 to the first main surface of the first substrate. In this case, receptacle housing 132 can be secured with respect to first substrate 131 more firmly. Thus, each terminal 23 can be electrically connected to each electrode pad 31b corresponding to terminal 23 more stably.

In connection system 101 according to the modification, second positioning member 150 includes third main body 151 and third securing members 152 that protrude from third main body 151 in a direction intersecting the Y direction and are secured to first main surface 131a of first substrate 131. In this case, second positioning member 150 can be secured with respect to first substrate 131. Thus, each terminal 23 can be electrically connected to each electrode pad 31b corresponding to terminal 23 more stably.

In the above embodiment, each distal end portion 21a of the plurality of electric wires 21 may be electrically connected to the corresponding terminal 23 among the plurality of terminals 23. For example, connection system 1 can exclude relay member 24. In this case, each distal end portion 21a of the plurality of electric wires 21 may be in contact with proximal end portion 23a of the corresponding terminal 23 among the plurality of terminals 23.

In the above embodiment, second side surface 44 of plug housing 40 is flush with first main surface 31a of first substrate 31, but may be flush with the upper surfaces of the plurality of electrode pads 31b of first substrate 31.

In the above embodiment, first securing member 60 secure receptacle housing 32 and first positioning member 50 to second main surface 33a of second substrate 33. For example, first securing member 60 may be an engagement member provided in plug housing 40 or receptacle housing 32.

What is claimed is:

1. A connection system comprising:
a plug including:
a plurality of conductors each extending along a first direction;
a plurality of terminals each electrically connected to a corresponding conductor among the plurality of conductors, each of the plurality of terminals extending along a second direction; and
a first housing holding distal end portions of the plurality of conductors and the plurality of terminals, the first housing including an end surface intersecting the second direction; and
a substrate member including a first substrate, wherein the first substrate includes a first main surface facing the end surface of the first housing in the second direction and a plurality of electrode pads disposed on the first main surface, wherein
the plurality of conductors are arranged side by side in a third direction intersecting the first direction and the second direction, and the plurality of terminals are arranged side by side in the third direction,
the plug is attached to the substrate member, and
each of the plurality of terminals includes a distal end portion facing the first main surface on the end surface of the first housing and configured to come into contact with a corresponding electrode pad among the plurality of electrode pads in an elastically deformed state.

2. The connection system according to claim 1, wherein
the plug further includes a relay member held by the first housing and holding a proximal end portion of each of the plurality of terminals in the second direction, and
the proximal end portion of each of the plurality of terminals is electrically connected to a corresponding conductor among the plurality of conductors at the relay member.

3. The connection system according to claim 1, wherein
the substrate member further includes a second housing accommodating the plug such that the first direction in which the plurality of conductors extend intersects the second direction and the plug and the first substrate are positioned with respect to each other.

4. The connection system according to claim 3, wherein
the plurality of conductors are arranged side by side in the second direction in a cross section of the first housing intersecting the third direction, and
the plurality of terminals are arranged side by side in the first direction in the cross section of the first housing intersecting the third direction.

5. The connection system according to claim 3, wherein
the substrate member further includes:
a second substrate including a second main surface intersecting the second direction; and
a first positioning member disposed on the second main surface and configured to position the second housing with respect to the second substrate in a direction intersecting the second direction.

6. The connection system according to claim 5, wherein
the substrate member further includes a first securing member configured to secure the second housing and the first positioning member to the second main surface of the second substrate.

7. The connection system according to claim 6, wherein
the first securing member includes a first main body and a first screw member configured to secure the first main body to the second main surface of the second substrate.

8. The connection system according to claim 3, wherein
the substrate member further includes a second positioning member disposed on the first main surface and configured to position the second housing with respect to the first substrate in a direction intersecting the second direction.

9. The connection system according to claim 8, wherein
the substrate member further includes a second securing member configured to secure the second housing and the second positioning member to the first main surface of the first substrate.

10. The connection system according to claim 9, wherein
the second securing member includes a second main body and a second screw member configured to secure the second main body to the first main surface of the first substrate.

11. The connection system according to claim 8, wherein
the second positioning member includes a third main body and a third securing member protruding from the third main body in the direction intersecting the second direction and secured to the first main surface of the first substrate.

12. A plug attachable to a substrate member including a plurality of electrode pads, the plug comprising:
a plurality of conductors each extending along a first direction;
a plurality of terminals each electrically connected to a corresponding conductor among the plurality of conductors, each of the plurality of terminals extending along a second direction; and
a first housing holding distal end portions of the plurality of conductors and the plurality of terminals, the first housing including an end surface intersecting the second direction, wherein
the plurality of conductors are arranged side by side in a third direction intersecting the first direction and the second direction, and the plurality of terminals are arranged side by side in the third direction,
each of the plurality of terminals includes a distal end portion protruding from the end surface of the first housing and configured to be contactable with a corresponding electrode pad among the plurality of electrode pads in an elastically deformed state.

13. The plug according to claim 12, further comprising:
a relay member held by the first housing and holding a proximal end portion of each of the plurality of terminals in the second direction, wherein
the proximal end portion of each of the plurality of terminals in the second direction is electrically connected to a corresponding conductor among the plurality of conductors at the relay member.

14. A substrate member attachable to a plug including an end surface from which a plurality of terminals, each extending along a second direction, are exposed, the substrate member comprising:
a substrate including a main surface intersecting the second direction, and a plurality of electrode pads disposed on the main surface, each of the plurality of electrode pads being configured to be electrically connectable to a corresponding terminal among the plurality of terminals.

15. The substrate member according to claim 14, further comprising:
a housing accommodating the plug such that the plug and the substrate are positioned with respect to each other.
